(19) United States
(12) Patent Application Publication
(10) Pub. No.: US 2025/0364194 A1
(43) Pub. Date: Nov. 27, 2025

(54) SWITCH AND LOCK DEVICE

(71) Applicant: ASSA ABLOY AB, Stockholm (SE)

(72) Inventors: Per Kristian Moller, Moss (NO); Harald VESTØL, Kolbotn (NO); Erik Holst-Larsen, Oslo (NO)

(21) Appl. No.: 18/873,499

(22) PCT Filed: Jun. 1, 2023
(86) PCT No.: PCT/EP2023/064707

§ 371 Date: Dec. 10, 2024

(30) Foreign Application Priority Data
Jun. 17, 2022 (SE) 2250736-2

(51) Int. Cl. H01H 13/18; E05B 17/22; H01H 13/04; H01H 13/52

(52) U.S. Cl. CPC H01H 13/18; E05B 17/22; H01H 13/04; H01H 13/52

(57) ABSTRACT

A switch comprising a printed circuit board assembly, PCBA, including a printed circuit board, PCB, and a stationary contact; a cap in contact with the PCB such that the cap and the PCB define a switch chamber for the stationary contact, the cap carrying a movable contact, the cap being arranged to be deformed from a disconnected state where the movable contact is separated from the stationary contact to a connected state where the movable contact contacts the stationary contact, and the cap being forced towards the disconnected state; an actuator movable relative to the stationary contact between an activated position where the actuator pushes the cap to the connected state, and a deactivated position allowing the cap to be forced to the disconnected state; and a potting compound enclosing the PCB and the cap. A lock device comprising a switch is also provided.

### TECHNICAL FIELD

The present disclosure generally relates to switches. In particular, a switch and a lock device comprising a switch, are provided.

### BACKGROUND

A wide range of different types of lock devices are known. One example of a lock device is a lock case having a bolt that can move between a retracted position and an extended position. A lock device may comprise or be associated with many different movable components. Examples of such movable components comprise a door leaf, a lock cylinder, a latchbolt, a deadbolt, a handle, a privacy thumbturn and screws.

For various reasons, it may be desired to detect a position of a movable component in (or associated with) a lock device. One reason may be to monitor a state of the lock device, for example to detect misuse or errors. Another reason may be that the lock device relies on a position of a movable component to trigger an electronic function.

It is previously known to use a sensor in a lock device to detect a position of a movable component, such as an optical sensor. However, prior art sensors for lock devices are often bulky, complicated, not sufficiently protected and/or error prone.

### SUMMARY

One object of the invention is to provide an improved switch.

A further object of the invention is to provide an improved lock device comprising a switch.

These objects are achieved by the switch according to appended claim 1 and the lock device according to appended claim 14.

The invention is based on the realization that by providing a switch comprising a deformable cap in contact with a printed circuit board, PCB, and a potting compound enclosing the PCB and the cap, a very efficient climate protection is accomplished for the switch.

According to a first aspect, there is provided a switch comprising a printed circuit board assembly, PCBA, including a printed circuit board, PCB, and a stationary contact; a cap in contact with the PCB such that the cap and the

PCB define a switch chamber for the stationary contact, the cap carrying a movable contact, the cap being arranged to be deformed from a disconnected state where the movable contact is separated from the stationary contact to a connected state where the movable contact contacts the stationary contact, and the cap being forced towards the disconnected state; an actuator movable relative to the stationary contact between an activated position where the actuator pushes the cap to the connected state, and a deactivated position allowing the cap to be forced to the disconnected state; and a potting compound enclosing the PCB and the cap.

The potting compound and the cap provide a full climate protection of the movable contact and the stationary contact, such as a protection against moisture and water. The switch can be used as a sensor in a lock device to monitor various states of the lock device. Examples of such states comprise a state of a door leaf (closed or open), a state of a lock cylinder (locked or unlocked), a state of a bolt (extended or retracted), a state of a handle (neutral or depressed), a state of a privacy thumbturn (locked or unlocked), and a state of a fastener (mounted or unmounted). The bolt may for example be a latchbolt or a deadbolt.

The switch has a durable design enabling the cap to remain in any of a deactivated state and an activated state for several years. When the cap adopts the disconnected state and the actuator adopts the deactivated position, the switch adopts the deactivated state. Conversely, when the cap adopts the connected state and the actuator adopts the activated position, the switch adopts the activated state. Since the switch is compact and reliably climate protected, the switch enables easy introduction to the lock device without compromising the design and functionality of the lock device.

If no external force acts on the actuator, the cap will be forced to the disconnected state and the cap will thereby push the actuator to the deactivated position. The switch is thus a non-tactile switch.

In the connected state, the movable contact may contact the stationary contact to close an electric circuit, e.g. between two electric conductors of the stationary contact. The stationary contact may for example be a finger contact.

The cap covers the movable contact and the stationary contact. The cap may be molded. Alternatively, or in addition, the cap may be made of silicone.

In the disconnected state, the movable contact is separated from the stationary contact in a separation direction. When the cap deforms from the disconnected state to the connected state, the movable contact moves to the stationary contact along the separation direction. The potting compound may be positioned outside the cap with respect to the separation direction. Thus, the potting compound may surround the cap in a plane substantially transverse to, or transverse to, the separation direction.

The cap may sealingly contact the PCB at an interface to sealingly close the switch chamber. In this case, the potting compound may seal the interface. Thus, both the cap and the potting compound may contribute to sealing the switch chamber. In this way, it can be avoided that the potting compound enters the switch chamber during molding of the potting compound. Absence of potting compound inside the switch chamber enables the stationary contact to be placed directly on the PCB. This in turn enables elimination of wiring between the stationary contact and the PCB.

When the cap sealingly contacts the PCB at the interface, the cap is both involved in the function of activating and deactivating the switch and in a function of sealing the switch chamber. The interface may be positioned between the potting compound and the switch chamber. The cap may comprise a frame sealingly contacting the PCB. The frame may be a lip.

The actuator may be rotatable between the activated position and the deactivated position. By providing a switch having a deformable cap and an actuator that is rotatable to activate the switch by deforming the cap, the switch can be made compact, the switch can be actuated with a low force and a durable design is enabled. In particular, the switch enables a low building height in the separation direction between the stationary contact and the movable contact. The rotatable arrangement of the actuator enables a short stroke of the movable contact and therefore contributes to a very compact design.

The actuator may be an arm or a pedal. Alternatively, or in addition, the actuator may be made of sheet metal. A total length of the actuator may be less than 10 mm, such as less than 5 mm.

The actuator may be rotatable about a rotation axis. The actuator may be elongated in a direction transverse to the rotation axis.

The actuator may comprise a cap section configured to contact and push the cap in the activated position and a target section for being contacted by a target member. The target member may be a member of the lock device but may be external to the switch. The movable contact may be positioned on a straight line between the cap section and the stationary contact in each state of the switch.

The cap section may be positioned between the rotation axis and the target section. Alternatively, or in addition, the cap section may be flat and oriented transverse to the separation direction when the actuator adopts the deactivated position.

The actuator may be connected to the cap. The actuator may comprise a base and the cap may comprise a frame. In this case, the base may be fixed to the frame.

The switch may further comprise a spring arranged to force the cap towards the disconnected state. The spring ensures that the cap does not get stuck in the connected state and reliably prevents false activations of the switch, such as from vibrations. Moreover, the spring enables an improved durability of the switch. The switch can for example be switched over a million times and can be switched to the deactivated state after being in the activated state for 10 years, or vice versa. The spring may be positioned between the cap and the PCB.

As an alternative to a spring in addition to the cap, the cap may itself be configured to flexibly return to the disconnected state. In this case, the disconnected state may be a neutral state of the cap and the connected state may be a deformed state of the cap.

The cap may cover the spring. The spring may thus be provided inside the switch chamber.

The spring may be a washer. The washer enables a compact design of the switch. The washer may comprise an annular body.

According to one variant, the spring is a finger spring washer. The finger spring washer may comprise a plurality of bent fingers extending from the annular body. A finger spring washer reduces skidding and thereby enables a more reliable operation of the switch.

The cap may comprise a contact section and a dome surrounding the contact section. In this case, the contact section may carry the movable contact. Moreover, the cap may be arranged to deform from the disconnected state to the connected state by deformation of the dome. The dome may thus be flexible.

The contact section may be substantially stiffer, such as at least 50% stiffer, than the dome. In one variant, the contact section is cylindrical. The contact section may be received through the annular body of the washer.

The contact section may protrude from two opposite sides of the dome. In this case, the cap section may be configured to contact the contact section in the activated position.

The switch may further comprise a stationary structure including a recess for receiving the actuator in the activated position. In this case, the actuator may be positioned outside the recess in the deactivated position.

The cap may sealingly engage the stationary structure. In this way, it can be avoided that the potting compound enters a space between the stationary structure and the cap.

The stationary structure may be a switch housing. Alternatively, or in addition, the stationary structure may be made of plastic.

The target section may be arranged to be received in the recess. In this case, the target section may be positioned outside the recess in the deactivated position.

The stationary structure may comprise a top surface. The recess may be an opening in the top surface. The actuator may be capable of being positioned such that no part of the actuator protrudes above the top surface in the activated position. This enables a very compact design of the switch.

According to a second aspect, there is provided a lock device comprising a switch according to the first aspect. The lock device may be a lock case. The lock device may comprise a plurality of switches according to the first aspect, such as at least three switches.

The lock device may further comprise a target member movable between a first position where the target member does not push the actuator, and a second position where the target member pushes the actuator from the deactivated position to the activated position.

The target member and the actuator may be made of different materials. In this way, friction can be reduced. According to one example, the target member is made of steel and the actuator is made of plastic. According to a further example, the target member is made of plastic and the actuator is made of metal.

According to a third aspect, there is provided a switch comprising a stationary contact; a cap covering the stationary contact and carrying a movable contact, the cap being arranged to be deformed from a disconnected state where the movable contact is separated from the stationary contact to a connected state where the movable contact contacts the stationary contact, and the cap being forced towards the disconnected state; and an actuator rotatable relative to the stationary contact between an activated position where the actuator pushes the cap to the connected state, and a deactivated position allowing the cap to be forced to the disconnected state.

The switch according to the third aspect may or may not comprise one, several or all features of the switch according to the first aspect.

According to a fourth aspect, there is provided a lock device comprising a switch according to the third aspect.

### BRIEF DESCRIPTION OF THE DRAWINGS

Further details, advantages and aspects of the present disclosure will become apparent from the following description taken in conjunction with the drawings, wherein:

FIG. 1: schematically represents a side view of a lock device comprising a switch;

FIG. 2: schematically represents a partial perspective view of the switch;

FIG. 3: schematically represents a further partial perspective view of the switch;

FIG. 4: schematically represents a perspective view of an actuator and a spring of the switch;

FIG. 5: schematically represents a perspective bottom view of a cap of the switch and the spring;

FIG. 6: schematically represents a partial cross-sectional side view of the switch when the actuator is in a deactivated position and the cap is in a disconnected state;

FIG. 7: schematically represents a partial cross-sectional side view of the switch when the actuator is in an activated position and the cap is in a connected state;

FIG. 8: schematically represents a cross-sectional side view of a potting arrangement; and

FIG. 9: schematically represents a cross-sectional side view of a further example of a potting arrangement.

### DETAILED DESCRIPTION

In the following, a switch and a lock device comprising a switch, will be described. The same or similar reference numerals will be used to denote the same or similar structural features.

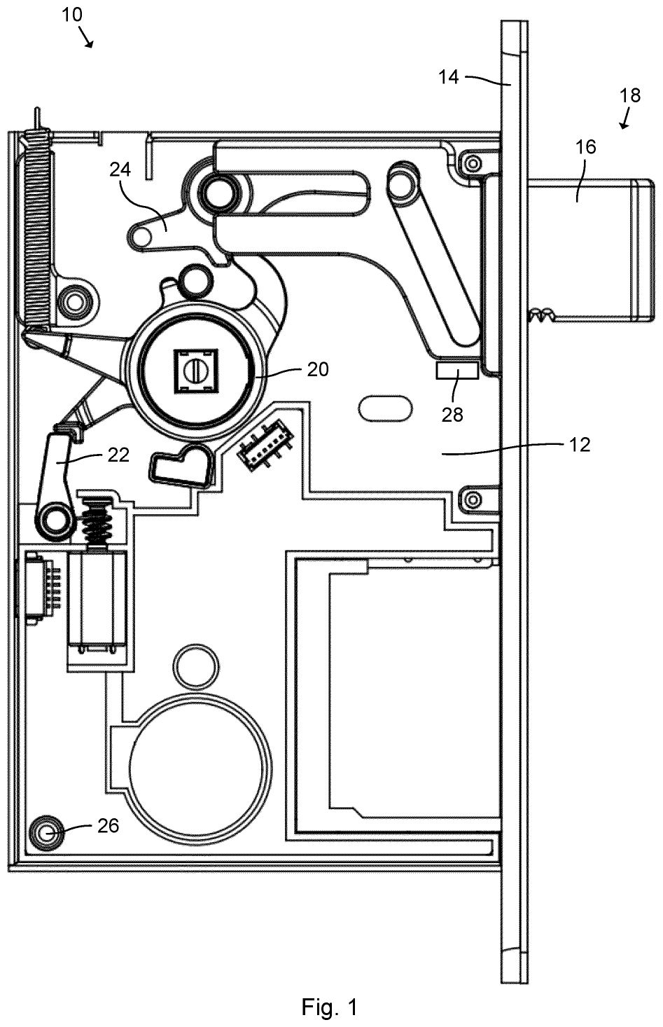

FIG. 1 schematically represents a side view of a lock case 10. The lock case 10 in FIG. 1 is one specific and non-limiting example, among many, of a lock device according to the present disclosure. The lock case 10 of this specific example comprises a lock housing 12, a forend 14 and a bolt 16. The bolt 16 is linearly movable from an illustrated extended position 18 to a retracted position through the forend 14 by manual actuation of a handle (not shown).

The lock case 10 of this example comprises a plurality of movable components. Each movable component is movable relative to the lock housing 12. In addition to the bolt 16, the lock case 10 of this example comprises a spindle 20, a blocking lever 22, a rotatable member 24 and a screw 26 constituting movable components. Further examples of movable components of, or associated with, the lock case 10 comprise a door leaf in which the lock case 10 is installed, the handle, a lock cylinder and a privacy thumbturn.

The lock case 10 comprises a switch 28. In the specific and non-limiting example in FIG. 1, the switch 28 is used as a sensor to detect a position of the bolt 16. The switch 28 may however be positioned elsewhere with respect to the lock case 10. The bolt 16 constitutes one example of a target member according to the present disclosure. Although only one switch 28 is shown in FIG. 1, the lock case 10 may comprises a plurality of switches 28, for example one switch 28 associated with one, several or all of the movable components. Except for the switch 28, the functionality of the lock case 10 is described in international patent application WO 2020126183 A1, the entirety of which is incorporated herein by reference.

As indicated in FIG. 1, the switch 28 has a very small size. The small size of the switch 28 is of great value since the space within the lock housing 12 is typically very limited. The small size of the switch 28 enables a higher number of switches 28 to be installed in the lock case 10. Consequently, the lock case 10 can be provided with an increased functionality and/or a reduced size in comparison with when using prior art switches.

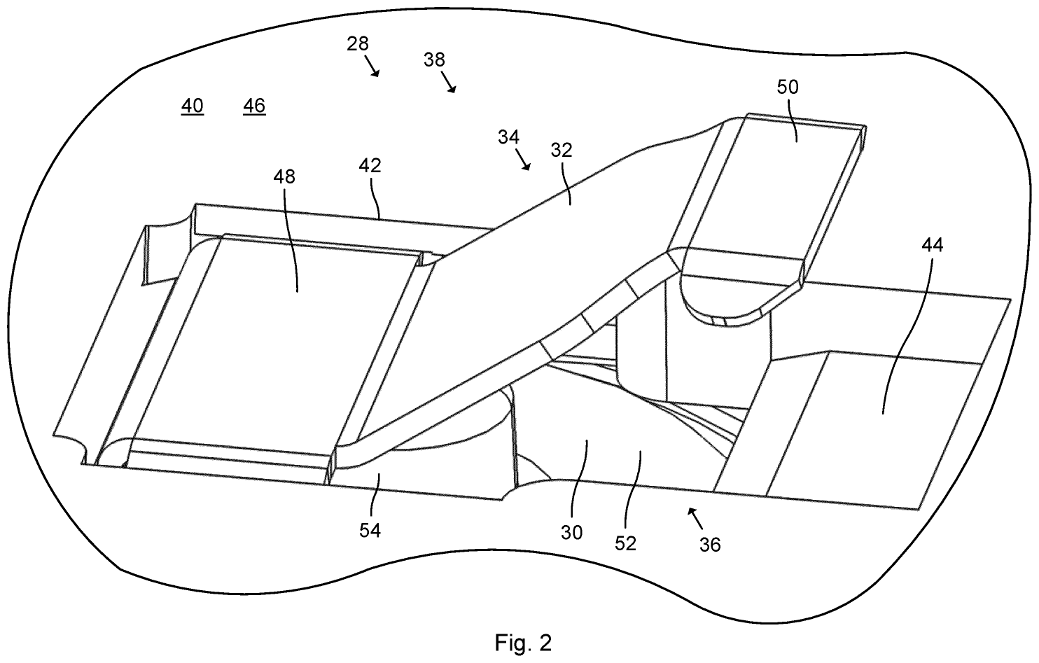

FIG. 2 schematically represents a partial perspective view of the switch 28. The switch 28 comprises a cap 30 and an arm 32. The arm 32 is one example of an actuator according to the present disclosure. In FIG. 2, the arm 32 is in a deactivated position 34 and the cap 30 is in a disconnected state 36. The switch 28 is thereby in a deactivated state 38.

The switch 28 of this example further comprises a switch housing 40. The switch housing 40 is one example of a stationary structure according to the present disclosure. The switch housing 40 may be made of plastic. The switch housing 40 comprises an opening 42. In the deactivated position 34, the arm 32 passes through the opening 42.

The switch housing 40 further comprises a recess 44 for receiving the arm 32. In this example, the recess 44 forms a part of the opening 42. The switch housing 40 comprises a top surface 46. The recess 44 is here a depression from the top surface 46.

The arm 32 of this example comprises a cap section 48 and a target section 50. The cap section 48 is configured to interact with the cap 30. The target section 50 is configured to interact with the bolt 16 or other target member.

In the deactivated position 34 of the arm 32, the target section 50 protrudes beyond the top surface 46. Thus, the top surface 46 is positioned between the target section 50 and the recess 44 in the deactivated position 34 of the arm 32.

As shown in FIG. 2, the cap 30 of this example comprises a dome 52 and a contact section 54. The contact section 54 is here exemplified as a central section surrounded by the dome 52. The contact section 54 of this example is cylindrical. The dome 52 is flexible. In this example, the cap section 48 contacts the contact section 54 and is parallel with the top surface 46 when the arm 32 is in the deactivated position 34.

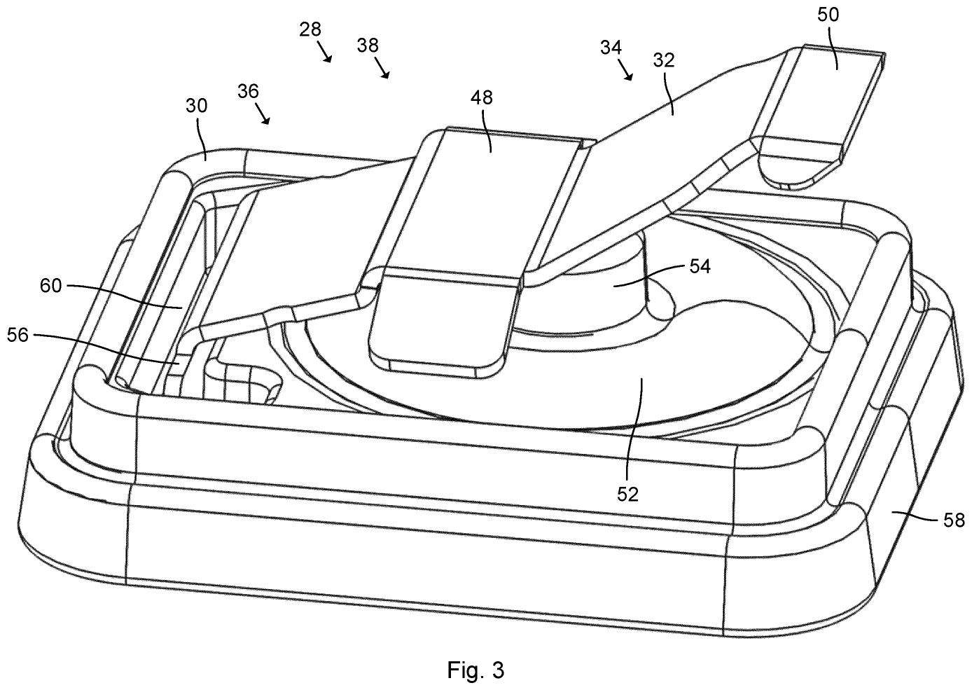

FIG. 3 schematically represents a further partial perspective view of the switch 28. Also in FIG. 3, the arm 32 is in the deactivated position 34, the cap 30 is in the disconnected state 36 and the switch 28 is in the deactivated state 38.

As shown, the arm 32 of this example further comprises a base 56. The cap section 48 is positioned between the base 56 and the target section 50.

The cap 30 of this example comprises a frame 58, here exemplified as a lip. The cap 30 forms a slot 60 between the frame 58 and the dome 52. In this example, the base 56 is secured in the slot 60. The arm 32 is thereby connected to the cap 30. The cap 30 of this example is molded from silicone. The frame 58 and the contact section 54 are thicker, and thereby more stiff, than the dome 52.

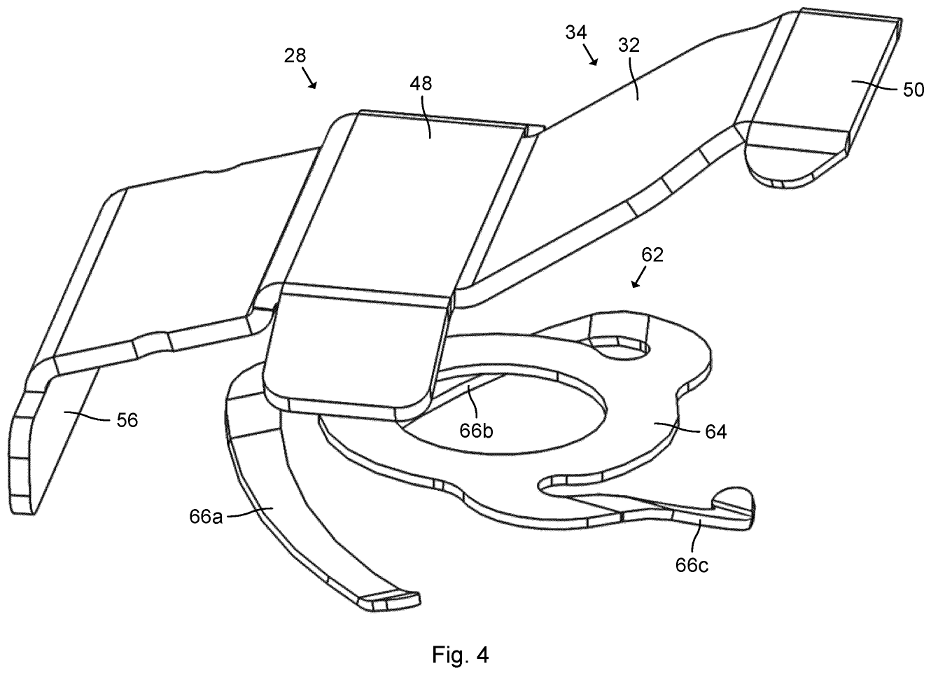

FIG. 4 schematically represents a perspective view of the arm 32 and a washer 62 of the switch 28. The arm 32 of this example is made of sheet metal. The arm 32 is elongated and comprises a plurality of bends to form the base 56, the cap section 48 and the target section 50. A maximum total length of the arm 32 of this example is less than 5 mm.

The washer 62 is one example of a spring according to the present disclosure. The washer 62 of this example is a finger spring washer. The washer 62 comprises an annular body 64 and a plurality of flexible fingers 66a-66c extending from the annular body 64, here three fingers 66a-66c. The fingers 66a-66c are bent relative to the annular body 64.

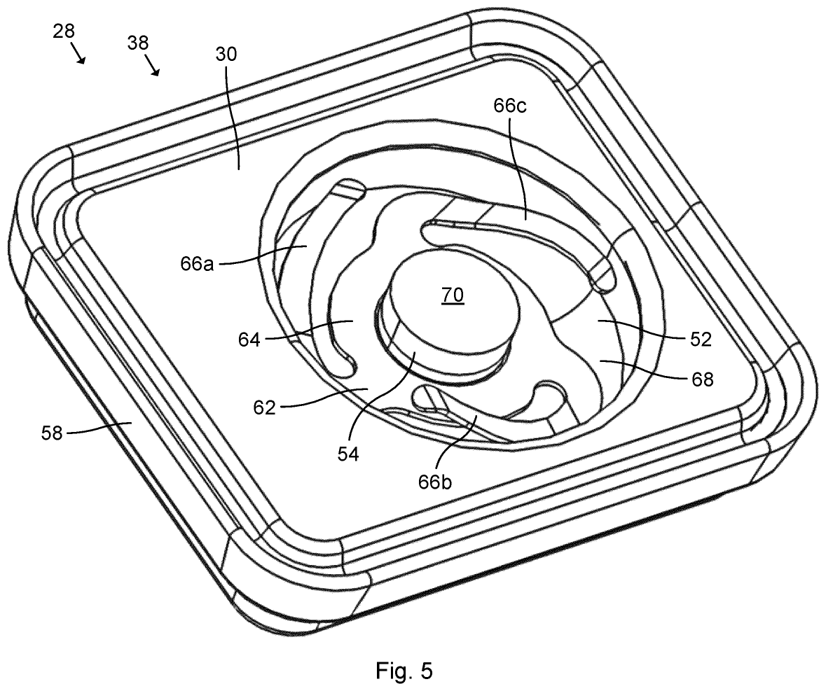

FIG. 5 schematically represents a perspective bottom view of the cap 30 and the washer 62. The dome 52 defines a switch chamber 68. The washer 62 is entirely accommodated inside the switch chamber 68. The contact section 54 passes through the annular body 64 of the washer 62.

As shown in FIG. 5, the switch 28 further comprises a movable contact 70, here exemplified as a carbon pillow. The movable contact 70 is carried by the cap 30. In this example, the movable contact 70 is carried by the contact section 54.

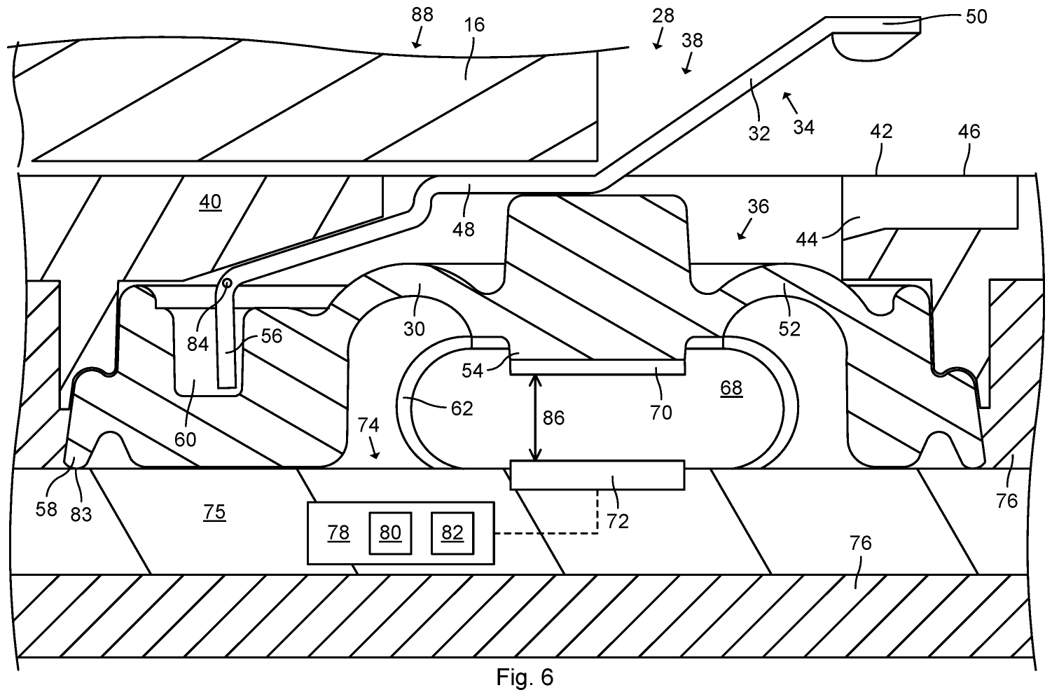

FIG. 6 schematically represents a partial cross-sectional side view of the switch 28. In FIG. 6, the arm 32 is in the deactivated position 34, the cap 30 is in the disconnected state 36 and the switch 28 is in the deactivated state 38. The switch 28 may remain in the illustrated deactivated state 38 for several years without deteriorated functionality. The switch 28 is a non-tactile switch. The switch 28 may be oriented in any direction in space.

As shown in FIG. 6, the switch 28 further comprises a stationary contact 72. The stationary contact 72 is stationary with respect to the switch housing 40. The cap 30 covers the washer 62, the movable contact 70 and the stationary contact 72. The stationary contact 72 may for example be a circuit, such as a gold plated circuit.

The switch 28 of this example further comprises a PCBA (printed circuit board assembly) 74. The PCBA 74 comprises the stationary contact 72. The PCBA 74 also comprises a PCB (printed circuit board) 75. As shown in FIG. 6, the stationary contact 72 is in this example positioned directly on the PCB 75.

The switch 28 of this example further comprises a potting compound 76. In this example, a part of the cap 30 and the PCB 75 are potted in the potting compound 76. The potting compound 76 is provided on two opposite sides of the PCB 75 with respect to a main extension plane of the PCB 75. The potting compound 76 can for example be polyurethane or epoxy. The switch 28 may be oriented upside down (in comparison with FIG. 6) when the potting compound 76 is poured and hardened.

The PCBA 74 of this example further comprises an electronic control system 78. The control system 78 comprises a data processing device 80 and a memory 82. The memory 82 has a computer program stored thereon. The computer program contains program code which, when executed by the data processing device 80, causes the data processing device 80 to perform, or command performance of, various steps. The computer program may for example contain program code which, when executed by the data processing device 80, causes the data processing device 80 to output a status signal indicative of whether or not the movable contact 70 is in contact with the stationary contact 72. The status signal may be sent to a central processor of the lock case 10 and/or to one or more external devices, for example wirelessly.

As shown in FIG. 6, the frame 58 sealingly contacts the PCB 75 at a contact interface 83. This sealed contact prevents the potting compound 76 from entering the switch chamber 68 during molding of the potting compound 76. The cap 30 thus both serves as a seal and as a functional part of the switch 28, i.e. contributing to activate and deactivate the switch 28. In this example, the potting compound 76 seals the interface 83 between the frame 58 and the PCB 75. An outer side of the frame 58 and surfaces of the PCB 75 outside of the switch chamber 68 are here embedded in the potting compound 76, as shown in FIG. 6. The cap 30 and the potting compound 76 thereby hermetically seal the switch chamber 68. The switch 28 is therefore reliably protected against moisture. Moisture may for example occur due to condensation of water in many implementations.

The cap 30 also sealingly engages the switch housing 40. Since the cap 30 sealingly engages both the switch housing 40 and the PCB 75, the cap 30 prevents the potting compound 76 from entering into the switch chamber 68 and from entering between the switch housing 40 and the cap 30. The switch 28 enables mounting of the cap 30 directly on the PCB 75, without requiring potting compound 76 inside the switch chamber 68 and while enabling a very reliable climate protection. Absence of potting compound 76 inside the switch chamber 68 enables the stationary contact 72 to be placed directly on the PCB 75.

In this example, the arm 32 is rotatable relative to the switch housing 40 and the PCBA 74 about a rotation axis 84. The arm 32 is elongated in a direction transverse to the rotation axis 84. The rotation axis 84 is in this specific example provided by a living hinge between the base 56 and the cap section 48. The arm 32 may however be rotatable relative to the switch housing 40 and the PCBA 74 in alternative ways.

As shown in FIG. 6, the contact section 54 comprises an outer part protruding outwardly from the dome 52 towards the arm 32 and an inner part protruding inwardly from the dome 52 towards the stationary contact 72. The outer part interacts with the cap section 48. The inner part carries the movable contact 70.

In the illustrated disconnected state 36 of the cap 30, the movable contact 70 is separated from the stationary contact 72 by a separation distance 86. The cap section 48 of this example is flat in a plane transverse to the separation distance 86 when the arm 32 is in the deactivated position 34.

In this example, the washer 62 acts between the PCBA 74 and the cap 30 to provide a force on the cap 30 away from the PCBA 74 such that the cap 30 is held in the disconnected state 36. As a consequence, the arm 32 is pushed to the deactivated position 34 by the cap 30, here by the engagement between the contact section 54 and the cap section 48. In this example, the arm 32 engages the switch housing 40 in the deactivated position 34. The switch housing 40 thus functions as a stop for the arm 32 in the deactivated position 34.

FIG. 6 further shows the bolt 16. In FIG. 6, the bolt 16 is in the retracted position 88. In the retracted position 88, the bolt 16 does not contact the arm 32. The arm 32 is thereby allowed to adopt the deactivated position 34 which in turn allows the cap 30 to be forced to the illustrated disconnected state 36. The retracted position 88 and the extended position 18 of the bolt 16 constitute examples of a first position and a second position, respectively, of a target member according the present disclosure.

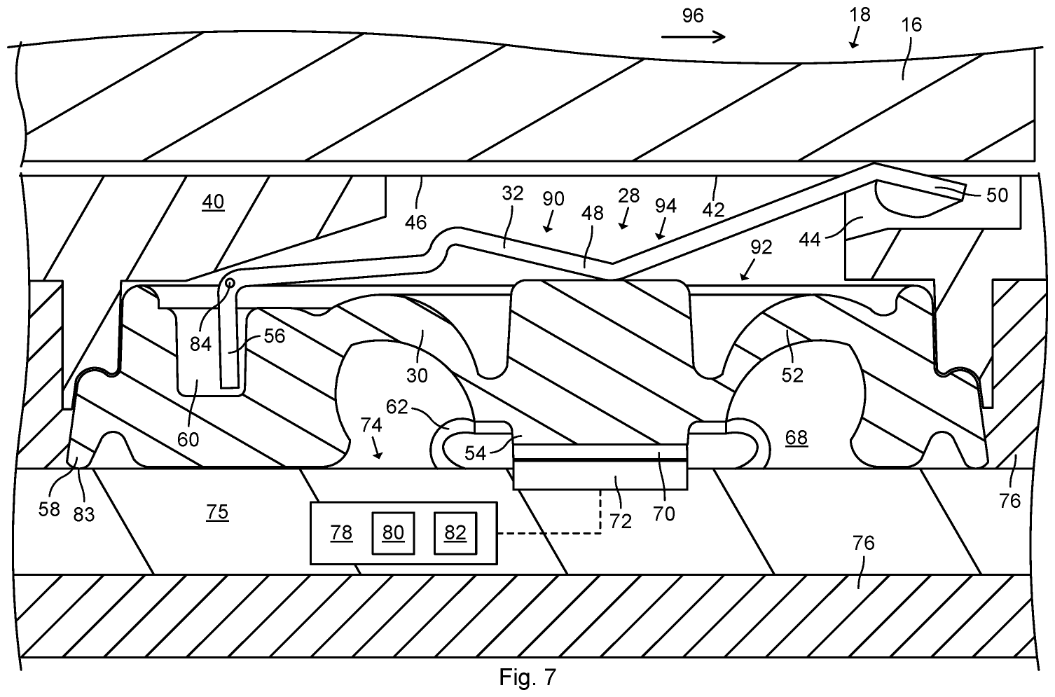

FIG. 7 schematically represents a partial cross-sectional side view of the switch 28. In FIG. 7, the arm 32 is in an activated position 90 and the cap 30 is in a connected state 92. The switch 28 is thereby in an activated state 94.

In FIG. 7, the bolt 16 has moved linearly from the retracted position 88 to the extended position 18 as shown with arrow 96. The bolt 16 can move very close to, and in parallel with, the top surface 46. During the movement of the bolt 16, the bolt 16 contacts the target section 50. The target section 50 is thereby pushed into the recess 44. As a consequence, the arm 32 (except the fixed base 56 thereof), rotates about the rotation axis 84 from the deactivated position 34 to the illustrated activated position 90. The bolt 16 may be provided with a plastic coating to reduce friction to the arm 32. Alternatively, the arm 32 may be made of plastic. As shown in FIG. 7, in case the bolt 16 passes closer to the top surface 46, the target section 50 can be pushed slightly further down into the recess 44 such that no part of the arm 32 is positioned above the top surface 46.

As the arm 32 rotates, the cap section 48 pushes on the contact section 54 such that the contact section 54 moves along the separation distance 86 against the force of the washer 62 and under deformation of the dome 52 until the movable contact 70 contacts the stationary contact 72 and the cap 30 adopts the connected state 92. The fingers 66a-66c of the washer 62 are deformed. The switch 28 is thereby activated by a sideway movement of the bolt 16. In this example, the cap section 48 remains above (in FIGS. 6 and 7) the contact section 54 in each of the deactivated state 38 and the activated state 94 of the switch 28.

The cap 30 and the potting compound 76 reliably prevents moisture from entering into the switch chamber 68. A reliable activation and deactivation of the switch 28 is thereby enabled.

The switch 28 enables a very light activation force and has a compact and climate protected design. Due to the washer 62, the switch 28 can remain in the activated state 94 for several years without risking to get stuck in the activated state 94. The switch 28 is therefore excellent to serve as a sensor in the lock case 10 or in another type of lock device.

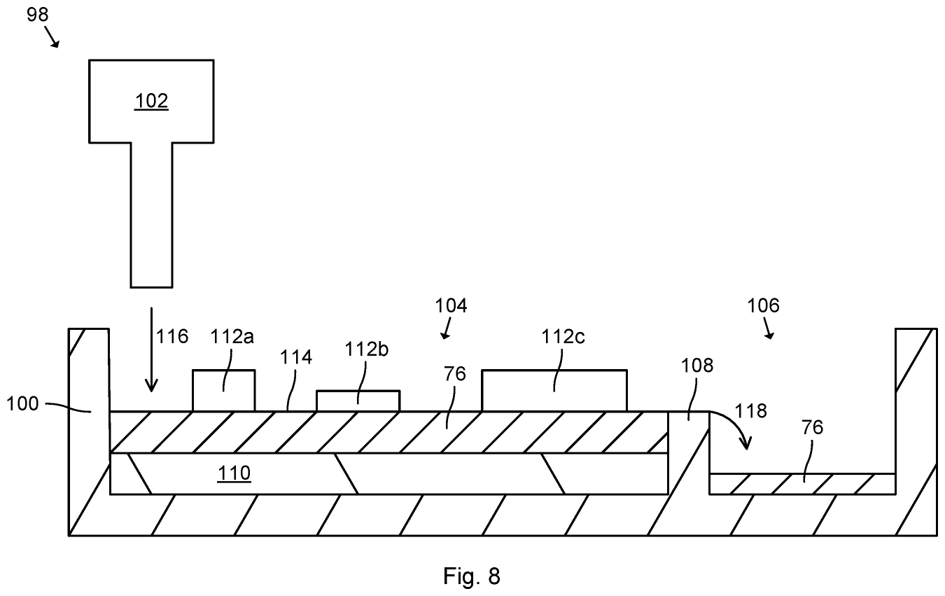

FIG. 8 schematically represents a cross-sectional side view of a potting arrangement 98. The potting arrangement 98 comprises a housing 100 and a potting tool 102. The housing 100 comprises a main chamber 104 and an overflow chamber 106, here next to the main chamber 104. The main chamber 104 and the overflow chamber 106 are separated by a partition structure, here exemplified as a wall 108. The potting arrangement 98 further comprises a PCBA including a PCB 110 and a plurality of electronic components placed thereon, here exemplified as a first electronic component 112a, a second electronic component 112b and a third electronic component 112c. The electronic components 112a-112c may for example comprise one or more sensors and/or one or more diodes.

In some implementations, a level 114 of potting compound 76 applied to the PCB 110 is important. A sufficient amount of potting compound 76 is needed to protect the electronic components 112a-112c, e.g. by covering connection points thereof. However, if a too high amount of potting compound 76 is applied, subsequent assembly processes may be negatively affected. Some potting tools also cannot provide an accurate amount of potting compound 76.

As shown in FIG. 8, the level 114 of potting compound 76 is defined by a height of the wall 108. When liquid potting compound 76 is poured onto the PCB 110 by the potting tool 102 as shown with arrow 116, any excess potting compound 76 passes over the wall 108 and into the overflow chamber 106 as shown with arrow 118. In this way, the amount of potting compound 76 that is provided to the main chamber 104 does not need to be as accurate. Dispensing accuracy requirements of the potting tool 102 can thereby be relaxed. As long as the amount of potting compound 76 at least reaches the top of the wall 108, but does not overfill the overflow chamber 106, the result will be a perfect amount of potting compound 76 in the main chamber 104, as indicated by the level 114. The housing 100 enables a fast pouring of potting compound 76 while accurately obtaining the desired level 114. The potting arrangement 98 thus speeds up the production process and increases quality of the potting process.

When the potting compound 76 has hardened, the electronic components 112a-112c are protected from vibrations and climate effects, such as temperature variations and moisture. Instead of the wall 108 having a height defining the level 114 of the potting compound 76 as shown in FIG. 8, a higher wall may be used and one or more through holes may be provided in this wall to establish a fluid communication between the main chamber 104 and the overflow chamber 106 and to define the level 114 of the potting compound 76. The potting principle described in connection with the potting arrangement 98 in FIG. 8 may be used when potting the cap 30 and the PCB 75 of the switch 28.

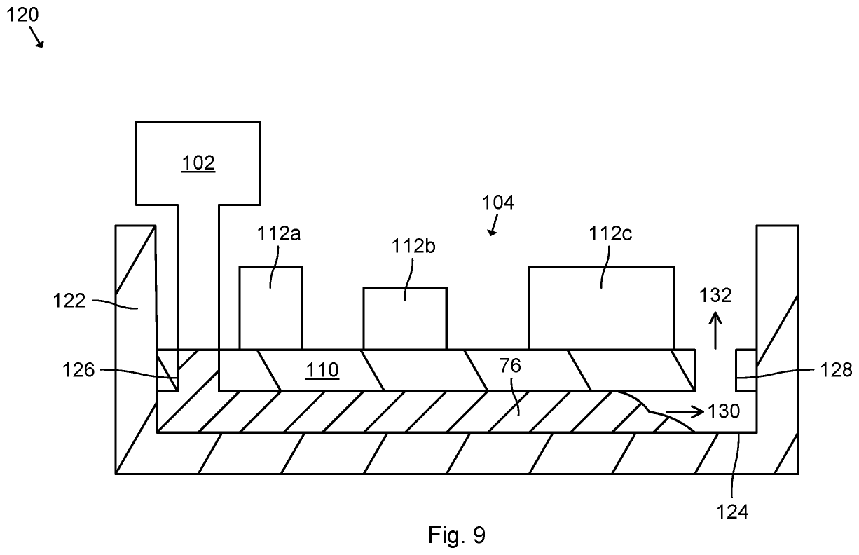

FIG. 9 schematically represents a cross-sectional side view of a further example of a potting arrangement 120. Mainly differences with respect to FIG. 8 will be described. The potting arrangement 120 comprises a housing 122 having the main chamber 104. The PCB 110 is arranged in the housing 122 such that a channel 124 is provided under the PCB 110. Moreover, the PCB 110 comprises a first through hole 126 and a second through hole 128, each in fluid communication with the channel 124.

By pouring potting compound 76 into the first through hole 126, e.g. by sealingly connecting the potting tool 102 to the first through hole 126, the potting compound 76 moves in the channel 124 as shown with arrow 130. The potting compound 76 thereby contacts the underside of the PCB 110. At the same time, air in the channel 124 is pushed out through the second through hole 128 by the moving potting compound 76 as shown with arrow 132. The potting process continues until the potting compound 76 fills the second through hole 128. In this way, potting compound 76 can be provided under the PCB 110 while eliminating formation of air pockets or air bubbles. The quality of the potting process is thereby improved. The potting process also eliminates a need to establish a vacuum environment.

The top of the PCB 110 may then be potted, for example using the potting process described in connection with FIG. 8. Also the potting principle described in connection with the potting arrangement 120 in FIG. 9 may be used when potting the cap 30 and the PCB 75 of the switch 28.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1-15. (canceled)

16. A switch comprising:
a printed circuit board assembly, PCBA, including a printed circuit board, PCB, and a stationary contact;
a cap in contact with the PCB such that the cap and the PCB define a switch chamber for the stationary contact, the cap carrying a movable contact, the cap being arranged to be deformed from a disconnected state where the movable contact is separated from the stationary contact to a connected state where the movable contact contacts the stationary contact, and the cap being forced towards the disconnected state;
an actuator movable relative to the stationary contact between an activated position where the actuator pushes the cap to the connected state, and a deactivated position allowing the cap to be forced to the disconnected state; and
a potting compound enclosing the PCB and the cap.

17. The switch according to claim 16, wherein the cap sealingly contacts the PCB at an interface to sealingly close the switch chamber, and wherein the potting compound seals the interface.

18. The switch according to claim 16, wherein the actuator is rotatable between the activated position and the deactivated position.

19. The switch according to claim 18, wherein the actuator is rotatable about a rotation axis.

20. The switch according to claim 19, wherein the actuator comprises a cap section configured to contact and push the cap in the activated position and a target section for being contacted by a target member.

21. The switch according to claim 20, wherein the cap section is positioned between the rotation axis and the target section.

22. The switch according to claim 16, wherein the actuator comprises a cap section configured to contact and push the cap in the activated position and a target section for being contacted by a target member.

23. The switch according to claim 16, further comprising a spring arranged to force the cap towards the disconnected state.

24. The switch according to claim 23, wherein the cap covers the spring.

25. The switch according to claim 23, wherein the spring is a washer.

26. The switch according to claim 16, wherein the cap comprises a contact section and a dome surrounding the contact section, wherein the contact section carries the movable contact, and wherein the cap is arranged to deform from the disconnected state to the connected state by deformation of the dome.

27. The switch according to claim 26, wherein the actuator comprises a cap section configured to contact and push the cap in the activated position and a target section for being contacted by a target member.

28. The switch according to claim 27, wherein the contact section protrudes from two opposite sides of the dome, and wherein the cap section is configured to contact the contact section in the activated position.

29. The switch according to claim 16, further comprising a stationary structure including a recess for receiving the actuator in the activated position, wherein the actuator is positioned outside the recess in the deactivated position.

30. The switch according to claim 29, wherein the actuator comprises a cap section configured to contact and push the cap in the activated position and a target section for being contacted by a target member.

31. The switch according to claim 30, wherein the target section is arranged to be received in the recess.

32. A lock device comprising a switch according to claim 16.

33. The lock device according to claim 32, further comprising a target member movable between a first position where the target member does not push the actuator, and a second position where the target member pushes the actuator from the deactivated position to the activated position.
